(19) United States
(12) Patent Application Publication
(10) Pub. No.: US 2012/0074195 A1
(43) Pub. Date: Mar. 29, 2012

(54) DRIVING UNIT FOR AN ELECTRIC NAIL GUN

(75) Inventors: Chia-Yu CHIEN, Taichung (TW); Chien-Kuo PO, Taichung (TW)

(73) Assignee: Basso Industry Corp., Taichung (TW)

(21) Appl. No.: 13/245,771

(22) Filed: Sep. 26, 2011

(30) Foreign Application Priority Data
Sep. 28, 2010 (TW) 099132771

(51) Int. Cl. B25C 1/06

(52) U.S. Cl. 227/147

(57) ABSTRACT

A driving unit for an electric nail gun includes a pushing block. The pushing block is movable relative to a supporting bracket of the electric nail gun along an axis, and has an inclined surface abutting against an end of a swing arm. Movement of the pushing block results in pivoting movement of the swing arm between a first position, and a second position farther away from a flywheel than the first position. The inclined surface has a slope between 0.087 and 0.7, so as to lock effectively the swing arm at the first position to thereby increase the nail-striking force of an impact member.

### CROSS-REFERENCE TO RELATED APPLICATION

This application claims priority of Taiwanese Application No. 099132771, filed on Sep. 28, 2010.

### BACKGROUND OF THE INVENTION

1. Field of the Invention

This invention relates to an electric nail gun, and more particularly to a driving unit for an electric nail gun.

2. Description of the Related Art

FIG. 1 shows a conventional electric nail gun 1 disclosed in Taiwanese application No. 099113274, which includes a supporting bracket 11, a trigger unit 12 disposed pivotally on the supporting bracket 11 and controlled by a control circuit to start a nail-driving operation, a motion transmitting unit 13, an impact unit 14, and a driving unit 15. The motion transmitting unit 13 includes a flywheel 131 disposed pivotally on the supporting bracket 11, and a motor 132 disposed on the supporting bracket 11 for driving high-speed rotation of the flywheel 131. The impact unit 14 includes a swing arm 141 disposed pivotally on the supporting bracket 11 and pivotable toward and away from the flywheel 131, and an impact member 142 disposed movably on the swing arm 141. The driving unit 15 includes a solenoid 151 disposed on the supporting bracket 11, an inclined pushing block 152 having an inclined surface abutting against an end of the swing arm 141, and a connecting rod 153 disposed pivotally on the supporting bracket 11 and connected between the solenoid 151 and the inclined pushing block 152.

In a normal state, the impact member 142 is spaced apart from the flywheel 131 by a distance of about 0.5 mm. When the trigger unit 12 is operated, the solenoid 151 activates the connecting rod 153 to move the inclined pushing block 152 to pivot the swing arm 141 and, thus, the impact member 142 toward the flywheel 131 until the impact member 142 comes into contact with the flywheel 131. Upon frictional contact of the impact member 142 with the flywheel 131, a relatively large pushing force is applied from the flywheel 131 to the impact member 142 to move the impact member 142 at a high speed for performing a nail-striking operation.

However, since the slope of the inclined surface of the inclined pushing block 152 is relatively small, during the nail-striking operation, a reaction force is applied to the swing arm 141 to reduce the pressure of the impact member 142 toward the flywheel 131, thereby reducing the nail-striking force and resulting in an instable nail-striking operation.

### SUMMARY OF THE INVENTION

The object of this invention is to provide an electric nail gun with an improved driving unit that can drive an impact member to perform a stable nail-striking operation.

According to this invention, a driving unit is adapted for an electric nail gun. The electric nail gun includes a supporting bracket, a flywheel disposed pivotally on the supporting bracket, a swing arm pivotable relative to the supporting bracket between a first position and a second position farther away from the flywheel than the first position, and an impact member pivotable with the swing arm relative to the supporting bracket to contact the flywheel to thereby be driven for performing a nail-striking operation. The driving unit includes a pushing block adapted to be movable relative to the supporting bracket along an axis and having an inclined surface adapted to abut against an end of the swing arm. Movement of the pushing block relative to the supporting bracket results in pivoting movement of the swing arm between the first and second positions. The inclined surface has a slope between 0.087 and 0.7, so as to lock effectively the swing arm at the first position to thereby increase the nail-striking force of an impact member.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a fragmentary schematic view of a conventional electric nail gun disclosed in Taiwanese application No. 099113274;

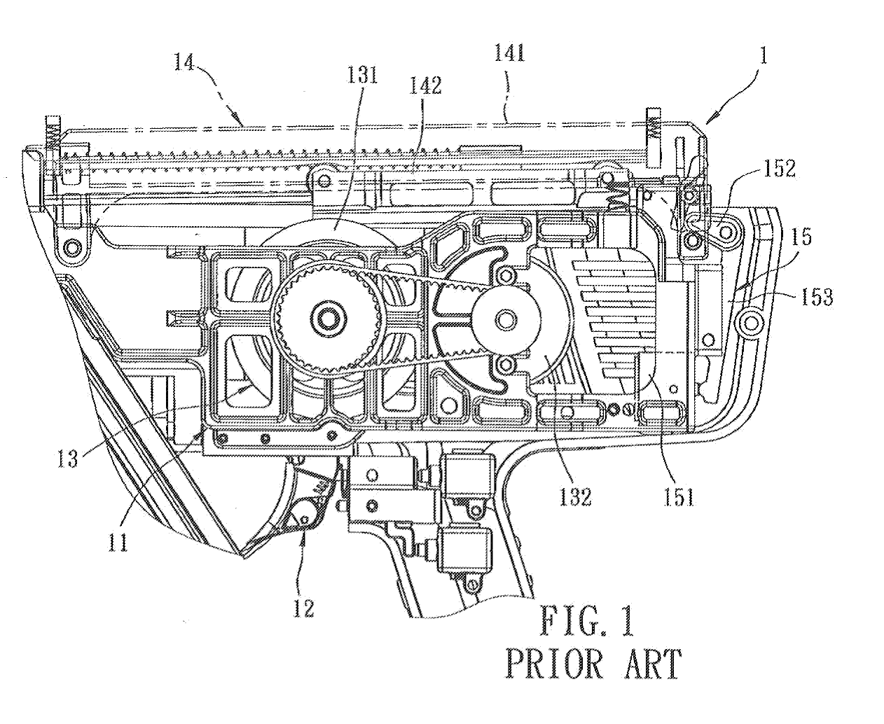

FIG. 2 is a fragmentary schematic view of the preferred embodiment of a driving unit for an electric nail gun according to this invention;

FIG. 3 is a schematic view illustrating an apex angle of a pushing block; and

FIG. 4 is a fragmentary, partly sectional schematic view of the preferred embodiment, illustrating frictional contact between an impact member and a flywheel.

### DETAILED DESCRIPTION OF THE PREFERRED EMBODIMENT

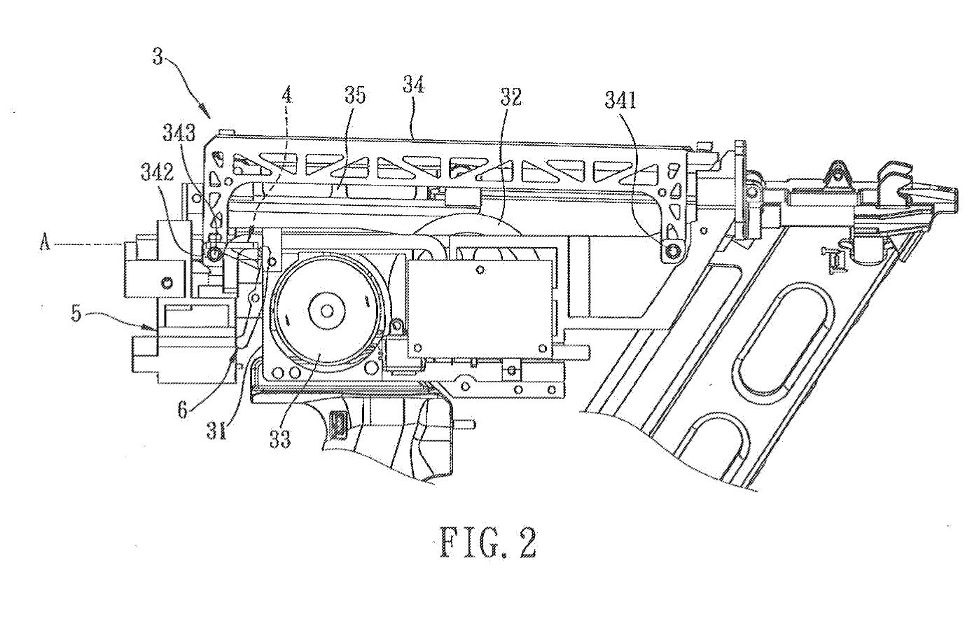

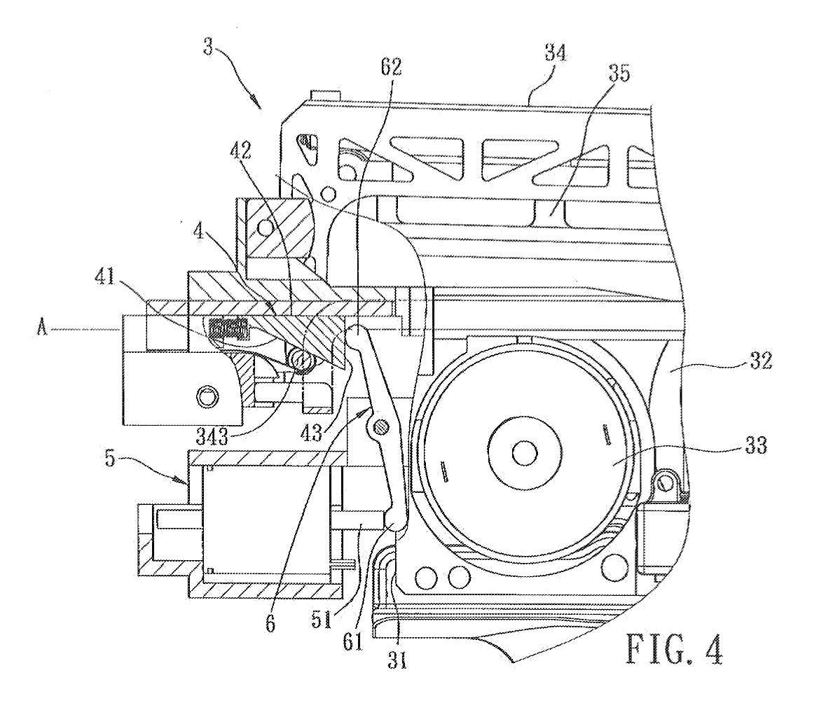

Referring to FIG. 2, the preferred embodiment of a driving unit is used for an electric nail gun 3. The electric nail gun 3 includes a supporting bracket 31, a flywheel 32 disposed pivotally on the supporting bracket 31, a motor 33 adjacent to the flywheel 32 for driving rotation of the flywheel 32 at a high speed, a swing arm 34 disposed pivotally on the supporting bracket 31, and an impact member 35 disposed movably on the swing arm 34. The swing arm 34 has a pivot end 341 connected pivotally to the supporting bracket 31, and a swinging end 342 opposite to the pivot end 342, and is pivotable between a first position shown in FIG. 4 and a second position shown in FIG. 2 that is farther away from the flywheel 32 than the first position. The driving unit includes a pushing block 4, a solenoid 5, and a connecting rod 6.

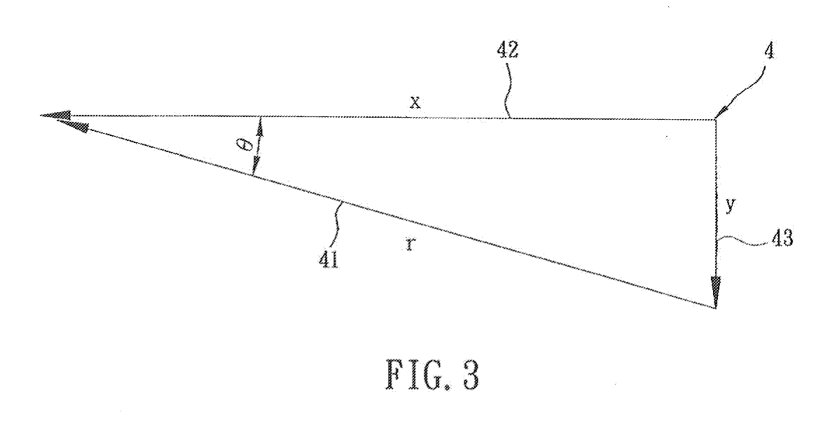

With further reference to FIG. 3, the pushing block 4 is right-triangle-shaped in cross-section, is movable on the supporting bracket 31 along an axis (A), and has an inclined surface 41 (i.e. hypotenuse side surface) abutting against the swinging end 342 of the swing arm 34, and a pair of first and second catheti side surfaces 42, 43. In this embodiment, the inclined surface 41 abuts against a laterally extending cylindrical projection 343 of the swinging end 342 of the swing arm 34. An apex angle (θ) is formed between the inclined surface 41 and the first catheti side surfaces 42, and is between 5 and 35 degrees. Preferably, the apex angle (θ) is between 10 and 30 degrees, and the inclined surface 41 and the swinging end 342 of the swing arm 34 have a coefficient of friction between 0.1 and 0.5.

The solenoid 5 is mounted to the supporting bracket 31, and includes a valve rod 51 movable on the supporting bracket 31 in a direction parallel to the axis (A).

The connecting rod 6 has an intermediate portion disposed pivotally on the supporting bracket 31, a rounded first end 61 abutting against an end of the valve rod 51 of the solenoid 5, and a rounded second end 62 abutting against the second catheti side surface 43.

In the case that the apex angle (θ) is between 5 and 35 degrees, the slope of the inclined surface 41 is:

$$tan θ = \frac{y}{x} = 0.087 \sim 0.7$$

In the case that the apex angle (θ) is between 10 and 30 degrees, the slope of the inclined surface 41 is:

$$tan θ = \frac{y}{x} = 0.176 \sim 0.577$$

With further reference to FIG. 4, when the solenoid 5 is energized to activate the connecting rod 6 to thereby move the pushing block 4 along the axis (A), the inclined surface 41 pushes the swinging end 342 of the swing arm 34 to pivot the swing arm 34 from the second position to the first position, so that the impact member 35 comes into contact with the flywheel 32. Hence, due to frictional contact between the impact member 35 and the flywheel 32, the impact member 35 is moved at a high speed by the flywheel 32 for performing a nail-striking operation.

Since the apex angle (θ) is increased, as compared to the above-mentioned prior art, a larger pressure can be exerted on the swing arm 34 by the pushing block 4, so as to lock the swing arm 34 at the first position, thereby strengthening the nail-striking force and facilitating a stable and smooth nail-striking operation.

With this invention thus explained, it is apparent that numerous modifications and variations can be made without departing from the scope and spirit of this invention. It is therefore intended that this invention be limited only as indicated by the appended claims.

I claim:

1. A driving unit adapted for en electric nail gun, the electric nail gun including a supporting bracket, a flywheel disposed pivotally on the supporting bracket, a swing arm pivotable relative to the supporting bracket between a first position and a second position farther away from the flywheel than the first position, and an impact member pivotable with the swing arm relative to the supporting bracket to contact the flywheel to thereby be driven for performing a nail-striking operation, said driving unit comprising a pushing block adapted to be movable relative to the supporting bracket along an axis and having an inclined surface adapted to abut against an end of the swing arm, said inclined surface having a slope between 0.087 and 0.7, movement of said pushing block relative to the supporting bracket resulting in pivoting movement of the swing arm between the first and second positions.

2. The driving unit as claimed in claim 1, wherein said inclined surface has a coefficient of friction between 0.1 and 0.5.

3. The driving unit as claimed in claim 1, wherein said slope of said inclined surface is between 0.176 and 0.577.

4. The driving unit as claimed in claim 1, wherein said pushing block is triangular in cross-section.

5. The driving unit as claimed in claim 1, further comprising a solenoid adapted to be mounted to the supporting bracket and including a valve rod adapted to be movable relative to the supporting bracket in a direction parallel to said axis.

6. The driving unit as claimed in claim 5, further comprising a connecting rod having an intermediate portion adapted to be disposed pivotally on the supporting bracket, a rounded first end abutting against an end of said valve rod, and a rounded second end abutting against said pushing block.
